(19) United States
(12) Patent Application Publication
(10) Pub. No.: US 2007/0205257 A1
(43) Pub. Date: Sep. 6, 2007

(54) SYSTEM FOR THE AUTOMATIC DISPLAY OF SEATING ASSIGNMENT INFORMATION AND METHOD OF USE THEREOF

(76) Inventors: Tony A. Melis, Candiac (CA); Thomas Moss, Brossard (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/613,683

(22) Filed: Dec. 20, 2006

(30) Foreign Application Priority Data
Jan. 4, 2006 (CA) 2,532,126

(51) Int. Cl. G06F 17/00; G06K 5/00

(52) U.S. Cl. 235/375; 235/380

(57) ABSTRACT

The present invention provides a novel system to automatically display the seating assignment of an attendee. The system comprises a processor in electronic communication with a database, an electronic reader and a display screen. The attendee wears a badge which comprises at least an computer readable portion itself comprising an identification number or code. When the electronic reader reads the identification number from the badge, the name and the seating assignment of the attendee are retrieved from the database and displayed on the display screen. A method is also provided thereof.

### CROSS-REFERENCE TO RELATED APPLICATIONS

There are no related applications.

### FIELD OF THE INVENTION

The present invention relates to a system and method for the display of seating assignment information. More particularly, the present invention relates to an automatic system for the display of the seating assignment information of a person wearing a computer readable badge.

### BACKGROUND OF THE INVENTION

During conventions, exhibitions, seminars and other similar events, there are usually opening banquets, closing banquets, large dinners, galas and/or luncheons (generally referred to as “banquets”) to which all the attendees are generally invited.

In small banquets, the seating assignment of the attendees is usually relatively easy. Furthermore, due to the smallness of the banquet, it is usually easy for the attendees to find their assigned seat, table or tables.

However, in larger banquets, when the number of tables is relatively large, it can easily become difficult for an attendee to find the seat or at least the seating area to which he or she has been assigned. Human guides can be provided but with an implied added cost. Moreover, human guides can generally give only approximate directions unless they personally guide each attendee to his or her assigned seat.

Posters or other similar passive physical displays can also be used to show a representation of the room and the placement of each table. However, such representation can only give general information and each attendee must know his or her table number in order to locate it adequately. Furthermore, should there be changes in the placement of the tables and/or in the seating assignment of the attendees, the posters would need to be updated, something which can hardly be done on short notice.

There is thus a need for a system which automatically displays the seating assignment information of an attendee.

### OBJECTS OF THE INVENTION

Accordingly, an object of the present invention is to provide a system for the automatic display of the seating assignment information of an attendee.

Another object of the present invention is to provide a system for the automatic display of the seating assignment information of an attendee which can be easily updated.

Still another object of the present invention is to provide a system for the automatic display of the seating assignment information of an attendee wherein the attendee is identified via a computer readable badge or tag.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

To attain these and other objects which will become more apparent as the description proceeds according to one aspect of the present invention, there is provided a system for the automatic display of the seating assignment information of an attendee.

In the system of the present invention, the attendee generally wears some kind of identification badge which generally comprises a human readable portion which can be read by a human and a computer readable portion which can be read by a computer via some electronic reading device. The human readable portion generally comprises a picture, a logo, the name of the attendee, its affiliation, an identification number and other similar relevant information. The computer readable portion generally comprises an identification number or code which is specifically coded to be readable by a computer via a reading device. Usually, the computer readable portion comes in the form of a barcode, a magnetic stripe, a RFID tag or an embedded chip (e.g. smart card with an embedded chip). In the preferred embodiment, the portion which is computer readable is a RFID tag but the skilled addressee will understand that the present system could work, albeit possibly less efficiently, with other computer readable media.

In the present invention, the entrance or entrances of the room or rooms where the event (e.g. a banquet) is held are equipped with RFID reader(s) and preferably a large electronic display. The RFID reader and the display are linked to a processor which is itself connected or linked to an electronic database directly or via a network (Local Area Network, Metropolitan Area Network, Wide Area Network and the like).

As the attendee enters the detection range of the RFID reader, the identification number of the attendee contained in the tag is read by the RFID reader. The identification number is then sent to the processor. The processor then looks in the electronic database for the relevant information concerning the attendee such as his/her name and his/her seating assignment. Other information such as the sex, the age group and/or the mother tongue of the attendee could be retrieved to create a more personalized system.

Once the relevant information are retrieved, the processor displays on the electronic display a map or representation of the room or rooms and superposes on the representation an indication of where the attendee is seated relative to the room or rooms.

Depending on the nature of the seating assignment information, the exact seat, the table or the group of tables (seating area) is preferably highlighted and the name of the attendee, with preferably an arrow pointing on the highlighted seat, table or group of tables, is displayed over the room representation. The attendee therefore has a clear, personalized and almost instantaneous indication of his/her seating assignment.

Since the system is linked to an electronic database, the system can be easily updated if last minute changes in the placement of the tables and/or in the assignment of the attendees occur.

Other aspects and many of the attendant advantages will be more readily appreciated as the same becomes better understood by reference to the following detailed description and considered in connection with the accompanying drawings in which like reference symbols designated like elements throughout the figures.

The features of the present invention which are believed to be novel are set forth with particularity in the appended claims.

### BRIEF DESCRIPTION OF THE DRAWINGS

FIG. 1 is a schematic view of the system of the present invention.

FIG. 2 is a view of an example of a room representation as displayed.

FIG. 3 is a view of an example of a room representation as displayed wherein attendee's seating information has been superposed.

FIG. 4 is a view of another example of a room representation as displayed wherein attendee's seating information has been superposed.

### DETAILED DESCRIPTION OF THE PREFERRED EMBODIMENT

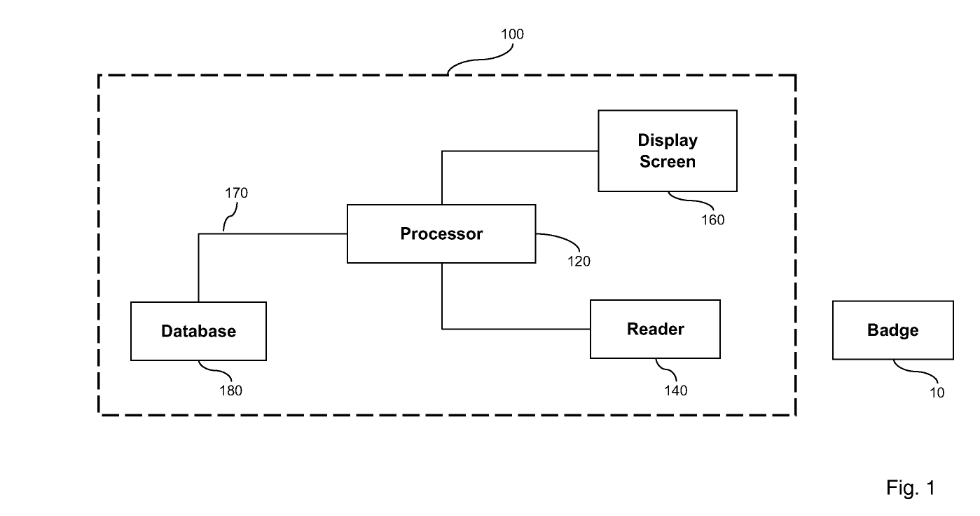

Referring to FIG. 1, a schematic view of the system 100 of the present invention is shown. The system generally comprises a processor 120 or any similar means to process electronic data. In a preferred embodiment, the processor 120 will be embodied into a computer for ease of utilization.

The system 100 further comprises an electronic reader 140. The reader 140 can be any electronic device which can read computer readable information. Preferably, the reader 140 is a RFID tag reader which are generally known in the art. The use of other readers such as a magnetic card reader, a barcode reader, an optical character recognition reader, an embedded chip reader and the like is also contemplated. The reader is in electronic communication with the processor 120.

The system 100 also comprises an electronic display system 160. The display 160 is preferably a large liquid crystal display (LCD) or a large plasma screen. However, other electronic displays could be used. The display 160 is also in electronic communication with the processor 120.

Finally, the system 100 comprises an electronic database 180 which contains information about each attendee. The minimal information stored in the database 180 are the identification number of the attendee, its name and its seating assignment. Understandably, other relevant information could be stored in the database for other purposes. The database 180 is also in electronic communication with the processor 120. The database 180 can be directly connected to the processor 120 or it can be linked to the processor 120 via a network (LAN, MAN, WAN, Internet and the like).

To function properly, the reader 140 of the system 100 is chosen to be able to read the computer readable portion of a badge 10 which is worn by an attendee. Since in the preferred embodiment, the computer readable portion of the badge 10 is a RFID tag, the reader 140 is preferably a RFID reader comprising at least an antenna and an antenna controller (not shown). In any case, the computer readable portion of the badge contains at least the identification number or code of the attendee.

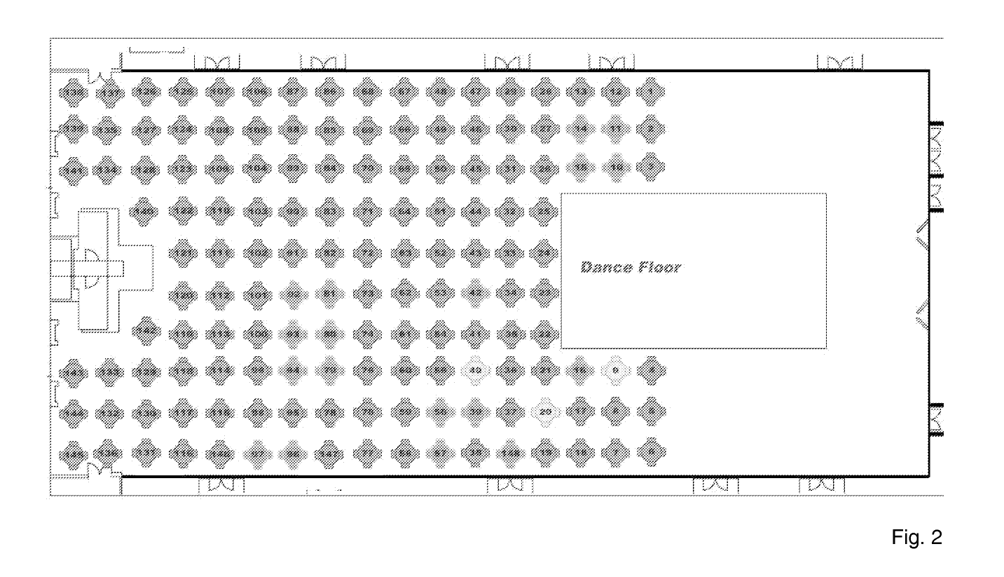

Now referring to FIG. 2, the display 160 of the system 100 is adapted to display information sent by the processor 120. In the preferred embodiment, the display 160 shows a representation of the room where the event is held. FIG. 2 shows an example of such a representation.

As an attendee which is wearing a badge 10 enters the reading range of the reader 140, the identification number stored in the computer readable portion of the badge 10 is read. The identification number is then sent to the processor 120 which requests, from the database 180, the name and the seating assignment information of the attendee associated with the identification number. The database 180 then sends this information to the processor 120.

Upon reception of the information from the database 180, the processor 120 translates the information into graphical information which are then sent to the display 160 to be preferably superposed on the representation of the room.

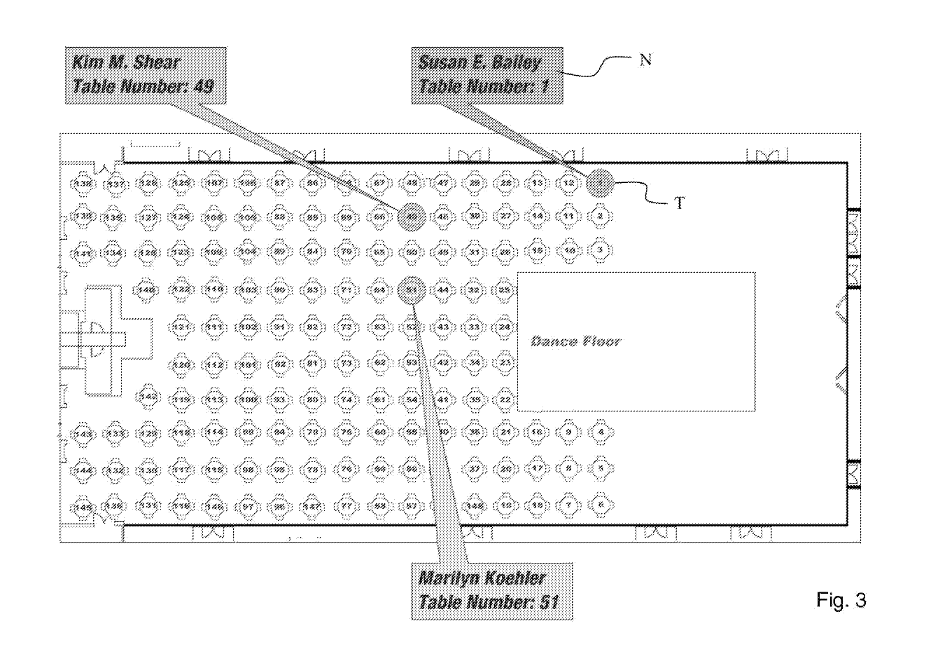

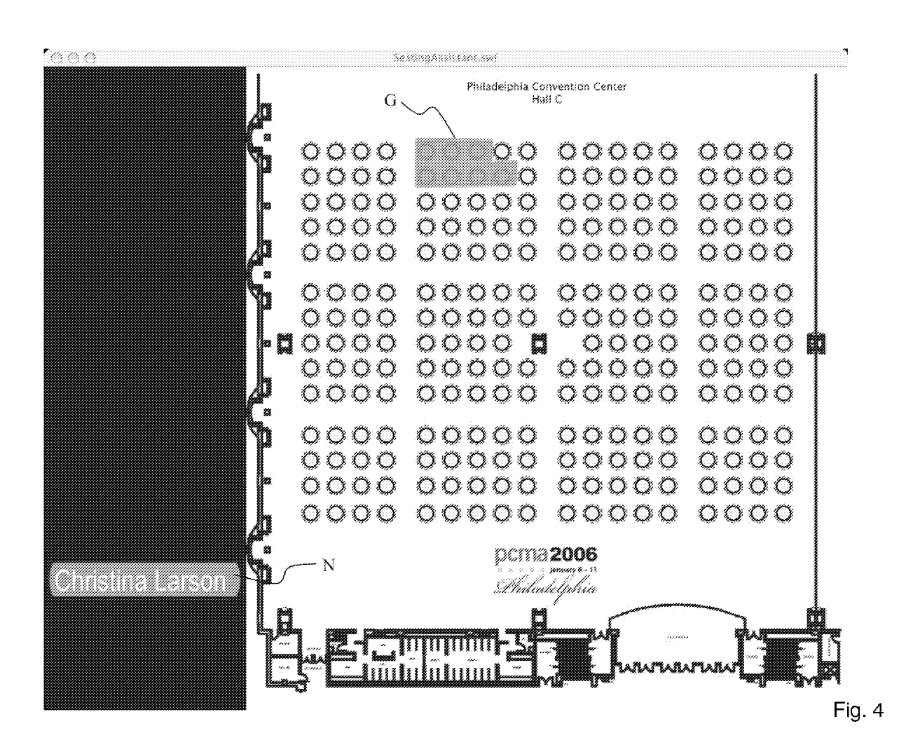

A preferred embodiment of the graphical information is shown in FIG. 3. As can be seen, the name of the attendee and its table number N are linked to the assigned table T which is itself highlighted. The attendee thus has a clear indication of where, in the room, is located the table to which he or she has been assigned. The attendee can enter the room and walk to its assigned table. Understandably, depending on the nature of the seating assignment (a seat, a table or a group of table), a single seat, a single table or a group of tables could be highlighted and linked to the name of the attendee. FIG. 4 shows another example of the representation of the graphical information wherein a group of tables G has been highlighted with the same color as the attendee's name N.

As can be seen in FIG. 3, the system 100 is adapted to provide seating location information to multiple attendee simultaneously. Moreover, if the room in which the event is held has multiple entrances, multiple systems 100 could be used. In such a case, more information could be displayed on the display 160 such as a “YOU ARE HERE” sign pointing to the entrance by which the attendee is entering the room. This would give the attendee information on how to reach its table based on its current position.

Understandably, the present invention can be used in other settings where the display of personalized location information are needed.

Although a preferred embodiment of the invention have been described in detail herein and illustrated in the accompanying figures, it is to be understood that the invention is not limited to these precise embodiments and that various changes and modifications may be effected therein without departing from the scope or spirit of the present invention.

1. A system for the display of seating assignment information associated with a person wearing a badge, said badge comprising at least a computer readable portion comprising at least an identification code, said system comprising:
a processor;
an electronic reader in electronic communication with said processor, said electronic reader adapted to read said identification code from said computer readable portion of said badge;
an electronic database in electronic communication with said processor;
a display screen in electronic communication with said processor;
wherein said system displays said seat assignment information associated with said person on said display screen when said identification code is read from said computer readable portion of said badge by said electronic reader.

2. A system as claimed in claim 1 wherein said computer readable portion of said badge is a RFID tag and said electronic reader is a RFID tag reader adapted to read said RFID tag from said badge.

3. A method to display seating assignment information associated with a person wearing a badge, said badge comprising at least a computer readable portion comprising at least an identification code, said method comprising the steps of:
a. reading said identification code from said badge;
b. retrieving said seating assignment information from a database;
c. providing said seating assignment information to a display screen;
d. displaying a graphical representation of said seating assignment information on said display screen.

4. A method as claimed in claim 3 wherein said computer readable portion of said badge is a RFID tag and said step a) is performed with a RFID tag reader adapted to read said RFID tag from said badge.
